(19) United States
(12) Patent Application Publication
(10) Pub. No.: US 2005/0190037 A1
(43) Pub. Date: Sep. 1, 2005

(54) Locker system, locker, portable key device, locker locking and unlocking method, and machine readable medium storing thereon computer program

(75) Inventors: Yasuhiro Shitan, Kanagawa (JP); Masahiro Ito, Tokyo (JP)

Correspondence Address: EDWARDS & ANGELL, LLP, P.O. BOX 55874, BOSTON, MA, 02205, US

(73) Assignee: Konami Sports Life Corporation, Tokyo (JP)

(21) Appl. No.: 11/123,348

(22) Filed: May 6, 2005

Related U.S. Application Data
(63) Continuation of application No. PCT/JP03/07904, filed on Jun. 23, 2003.

(30) Foreign Application Priority Data
Nov. 8, 2002 (JP) 2002-324984

(51) Int. Cl. H04B 1/00

(52) U.S. Cl. 340/5.5; 340/5.73; 235/375

(57) ABSTRACT

A portable key apparatus previously stores key identifying information, and outputs the key identifying information to a locker during locking the locker. The locker previously stores locker identifying information, and outputs the locker identifying information to the portable key apparatus during locking the locker. The portable key apparatus stores the locker identifying information received during locking the locker, and the locker stores the key identifying information received during locking the locker. The portable key apparatus outputs the stored locker identifying information and key identifying information to the locker during unlocking the locker. The locker checks the locker identifying information and key identifying information received during unlocking the locker with the key identifying information and locker identifying information stored thereon and decides the adequacy of unlocking of the locker based on the checked result.

The present application is a continuation application of PCT/JP03/07904 filed on Jun. 23, 2003, which claims priority from a Japanese Patent application No. 2002-324984 filed on Nov. 8, 2002, the entire contents of which are incorporated herein by reference for all purposes.

### BACKGROUND OF THE INVENTION

1. Field of the Invention

The present invention relates to a locker system, a portable key apparatus, a locker locking and unlocking method, and a machine readable medium storing thereon a computer program. More particularly, the present invention relates to a locker system, a portable key apparatus, a locker locking and unlocking method, and a machine readable medium storing thereon a computer program that perform locking and unlocking based on an electronic key and allow a user to select any vacant locker.

2. Description of Related Art

Lockers are provided in locker rooms of a gymnasium. As is generally known, after a user selects any vacant locker and puts a luggage in the selected locker, the user locks the locker by turning a key that is preliminarily inserted to the locker. Then, the user draws the key from the locker to carry around the key.

To prevent the key of the locker from being reproduced illegally, it is necessarily to prevent the user from carrying the key outside the gymnasium. For this purpose, it is desirable to manage the lent key in association with the user, for example, to individually hand the key to the user at a reception desk of the gymnasium.

On the other hand, considering convenience of the user, it is necessary that the user can freely select any vacant locker. However, in the conventional art in which the key is handed at the reception desk, the user can use only the specified locker.

### SUMMARY OF THE INVENTION

Therefore, it is an object of the present invention to provide a locker system, a portable key apparatus, a locker locking and unlocking method, and a machine readable medium storing thereon a computer program that can individually hand a key in association with each user and cause the user to use arbitrary locker. The above and other objects can be achieved by combinations described in the independent claims. The dependent claims define further advantageous and exemplary combinations of the present invention.

According to the first aspect of the present invention, there is provided a locker system. The locker system includes a locker and a portable key apparatus operable to perform locking and unlocking of the locker in communication with the locker, in which the portable key apparatus includes: a key-identifying-information storing unit that previously stores key identifying information that is identification information inherent in the portable key apparatus; and a key-side output unit that outputs the key identifying information stored on the key-identifying-information storing unit to the locker during locking the locker, the locker includes: a locker-identifying-information storing unit that previously stores locker identifying information that is identification information inherent in the locker; and a locker-side output unit that reads the locker identifying information from the locker-identifying-information storing unit to output the information to the portable key apparatus during locking the locker, the portable key apparatus further includes a key-side locking-time-information storing unit that stores the locker identifying information received from the locker-side output unit during locking the locker, the locker further includes a locker-side locking-time-information storing unit that stores the key identifying information received from the key-side output unit during locking the locker, and the locker further includes an adequacy-of-unlocking deciding unit that decides the adequacy of unlocking of the locker based on the locker identifying information stored on the key-side locking-time-information storing unit, the key identifying information previously stored on the key-identifying-information storing unit, the key identifying information stored on the locker-side locking-time-information storing unit, and the locker identifying information previously stored on the locker-identifying-information storing unit.

In the locker system, the portable key apparatus may further include an unlocking information generating unit that generates unlocking information to unlock the locker based on the locker identifying information stored on the key-side locking-time-information storing unit and the key identifying information stored on the key-identifying-information storing unit, the key-side output unit of the portable key apparatus may further output the unlocking information to the locker during unlocking the locker, and the adequacy-of-unlocking deciding unit of the locker may further check the unlocking information received during unlocking the locker with the key identifying information stored on the locker-side locking-time-information storing unit and the locker identifying information previously stored on the locker-identifying-information storing unit and decide the adequacy of unlocking of the locker based on the checked result.

Moreover, the key-side output unit of the portable key apparatus may further output the locker identifying information stored on the key-side locking-time-information storing unit and the key identifying information previously stored on the key-identifying-information storing unit to the locker during unlocking the locker, and the adequacy-of-unlocking deciding unit of the locker may check the locker identifying information and the key identifying information received during unlocking the locker with the key identifying information stored on the locker-side locking-time-information storing unit and the locker identifying information previously stored on the locker-identifying-information storing unit and decide the adequacy of unlocking of the locker based on the checked result.

Information exchange between the locker and the portable key apparatus may be performed using wireless communication system, the locker may further include a holding section that holds the portable key apparatus in a position of being able to send and receive the data between each other by radio, and the portable key apparatus may include an engaging section that is inserted into the holding section to engage with the locker.

In this case, the locker may further include a locking and unlocking mechanism that locks and unlocks the locker by rotating the key mechanically and also is able to be rotated in a unlocking direction when the adequacy-of-unlocking deciding unit allows unlocking, and the holding section of the locker may have a mobile mechanism that moves along with the portable key apparatus and rotates the locking and unlocking mechanism with this movement to perform locking or unlocking of the locker.

Moreover, the locker may further include a temporary fixed unit that temporarily fixes the portable key apparatus held in the holding section to the holding section and also enables that the portable key apparatus is removed from the holding section on condition that the key-side locking-time-information storing unit has stored the locker identifying information and the locker-side locking-time-information storing unit has stored the key identifying information respectively.

The locker may further include a locking and unlocking mechanism that locks or unlocks the locker by rotating the key mechanically, the portable key apparatus may further include an authentication data generation unit that generates authentication data indicating that the portable key apparatus is a normal product, the key-side output unit of the portable key apparatus may further output the authentication data to the locker during locking the locker, the locker may further include a verification unit that verifies whether the portable key apparatus is a normal product based on the authentication data, and the locking and unlocking mechanism of the locker may be able to be rotated when the verification unit has authenticated that the portable key apparatus is a normal product in the verification process.

In this case, the authentication data generation unit of the portable key apparatus and the verification unit of the locker may respectively include a data processing unit that processes the input data using the same method, the verification unit of the locker may output data to the authentication data generation unit and also store the data as it is during authenticating the key, the authentication data generation unit may generate the authentication data by processing the data by means of the data processing unit of the authentication data generation unit, and the verification unit may process the data stored thereon by means of the data processing unit of the verification unit and verify whether the portable key apparatus is a normal product based on the comparison result between the processed data and the authentication data received from the authentication data generation unit.

The locker may further include: a vacancy deciding unit that decides that the portable key apparatus does not lock the other locker when the locker identifying information is not already stored on the key-side locking-time-information storing unit during locking the locker; and a locking and unlocking mechanism that locks or unlocks the locker by rotating the key mechanically and also is able to be rotated in a locking direction when the vacancy deciding unit decides that the portable key apparatus does not lock the other locker.

The locker system may further include an administrative computer operable to store the key identifying information on the portable key apparatus and user identifying information identifying a user that holds the portable key apparatus in association with each other before using the locker.

In this case, the locker system may further include a reader operable to read the locker identifying information stored on the key-side locking-time-information storing unit and the key identifying information previously stored on the key-identifying-information storing unit from the portable key apparatus after locking the locker, and the administrative computer may store a pair of the locker identifying information and the key identifying information read from the reader in association with the user identifying information stored before the use of the locker.

According to the second aspect of the present invention, there is provided a portable key apparatus that performs locking and unlocking of a locker in communication with the locker. The portable key apparatus includes: a key-identifying-information storing unit operable to previously store key identifying information that is identification information inherent in the portable key apparatus; a key-side output unit operable to output the key identifying information stored on the key-identifying-information storing unit to the locker during locking the locker; and a key-side locking-time-information storing unit operable to receive locker identifying information that identifies the locker from the locker to store the information during locking the locker, in which the key-side output unit further outputs the key identifying information previously stored on the key-identifying-information storing unit and the locker identifying information stored on the key-side locking-time-information storing unit to the locker during unlocking the locker.

According to the third aspect of the present invention, there is provided a locker that is locked and unlocked based on input from a portable key apparatus held by a user. The locker includes: a locker-identifying-information storing unit operable to previously store locker identifying information that is identification information inherent in the locker; a locker-side output unit operable to read the locker identifying information from the locker-identifying-information storing unit to output the information to the portable key apparatus during locking the locker; a locker-side locking-time-information storing unit operable to receive key identifying information that identifies the portable key apparatus from the portable key apparatus to store the information during locking the locker; and an adequacy-of-unlocking deciding unit operable to receive the key identification information inherent in the portable key apparatus from the portable key apparatus during unlocking the locker and the locker identifying information output and stored from the locker-side output unit to the portable key apparatus during locking the locker, check the received information with the locker identifying information previously stored on the locker-identifying-information storing unit and the key identifying information stored on the locker-side locking-time-information storing unit, and decide the adequacy of unlocking of the locker based on the checked result.

According to the fourth aspect of the present invention, there is provided a locker system. The locker system includes a locker and a portable key apparatus operable to perform locking and unlocking of the locker in communication with the locker, in which the portable key apparatus includes: a key-identifying-information storing unit that previously stores key identifying information that is identification information inherent in the portable key apparatus; and a key-side output unit that outputs the key identifying information stored on the key-identifying-information storing unit to the locker during locking the locker, the locker includes a locker-side locking-time-information storing unit that stores the key identifying information received from the key-side output unit during locking the locker, the key-side output unit of the portable key apparatus further outputs the key identifying information stored on the key-identifying-information storing unit to the locker during unlocking the locker, and the locker further comprises an adequacy-of-unlocking deciding unit that checks the key identifying information received during unlocking the locker with the key identifying information stored on the locker-side locking-time-information storing unit and decides the adequacy of unlocking of the locker based on the checked result.

According to the fifth aspect of the present invention, there is provided a locker system. The locker system includes a locker and a portable key apparatus operable to perform locking and unlocking of the locker in communication with the locker, in which the locker includes: a locker-identifying-information storing unit that previously stores locker identifying information that is identification information inherent in the locker; and a locker-side output unit that reads the locker identifying information from the locker-identifying-information storing unit to output the information to the portable key apparatus during locking the locker, the portable key apparatus includes: a key-side locking-time-information storing unit that stores the locker identifying information received from the locker-side output unit during locking the locker; and a key-side output unit that outputs the locker identifying information stored on the key-side locking-time-information storing unit to the locker during unlocking the locker, and the locker further includes an adequacy-of-unlocking deciding unit that checks the locker identifying information received during unlocking the locker with the locker identifying information previously stored on the locker-identifying-information storing unit and decides the adequacy of unlocking of the locker based on the checked result.

According to the sixth aspect of the present invention, there is provided a locker locking and unlocking method that performs locking and unlocking of the locker using a portable key apparatus that communicates with the locker. The method includes: previously storing key identifying information that is identification information inherent in the portable key apparatus on the portable key apparatus; previously storing locker identifying information that is identification information inherent in the locker on the locker; outputting the key identifying information from the portable key apparatus to store the information on the locker and also outputting the locker identifying information from the locker to store the information on the portable key apparatus during locking the locker; and deciding the adequacy of unlocking of the locker based on the key identifying information stored on the locker during locking the locker, the locker identifying information stored on the portable key apparatus during locking the locker, the locker identifying information previously stored on the locker, and the key identifying information previously stored on the portable key apparatus.

In the locker locking and unlocking method, information exchange between the locker and the portable key apparatus may be performed using wireless communication system, and the locking and unlocking may be performed by inserting the portable key apparatus into a holding section that is provided in a position of being able to send and receive data between each other by radio in the locker to engage the portable key apparatus with the holding section.

Moreover, a locking and unlocking mechanism that locks or unlocks the locker by rotating the key mechanically may further be provided in the locker, the portable key apparatus may generate authentication data indicating that the portable key apparatus is a normal product to output the data to the locker during locking the locker, the locker may verify whether the portable key apparatus is a normal product based on the authentication data, and the locking and unlocking mechanism of the locker may be able to be rotated when the locker has authenticated that the portable key apparatus is a normal product in the verification process.

According to the seventh aspect of the present invention, there is provided a locker locking and unlocking method that performs locking and unlocking of the locker using a portable key apparatus that communicates with the locker. The method includes: previously storing key identifying information that is identification information inherent in the portable key apparatus on the portable key apparatus; outputting the key identifying information from the portable key apparatus to store the information on the locker during locking the locker; and deciding the adequacy of unlocking of the locker based on the key identifying information previously stored on the portable key apparatus and the key identifying information stored on the locker during locking the locker.

According to the eighth aspect of the present invention, there is provided a locker locking and unlocking method that performs locking and unlocking of the locker using a portable key apparatus that communicates with the locker. The method includes: previously storing locker identifying information that is identification information inherent in the locker on the locker; outputting the locker identifying information from the locker to store the information on the portable key apparatus during locking the locker; and deciding the adequacy of unlocking of the locker based on the locker identifying information previously stored on the locker and the locker identifying information stored on the portable key apparatus during locking the locker.

According to the ninth aspect of the present invention, there is provided a machine readable medium storing computer program capable of being realized by a computer built in a portable key apparatus that performs locking and unlocking of a locker in communication with the locker. The program causes the computer to act as: means for outputting key identifying information, which is previously stored on the computer and is identification information inherent in the portable key apparatus, from the portable key apparatus to the locker during locking the locker; means for receiving locker identifying information that identifies the locker from the locker to store the information on the portable key apparatus during locking the locker; and means for outputting the key identifying information and the locker identifying information stored on the portable key apparatus to the locker during unlocking the locker.

According to the tenth aspect of the present invention, there is provided a machine readable medium storing computer program capable of being realized by a computer provided in a locker and for locking and unlocking the locker by way of a portable key apparatus held by a user. The program causes the computer to act as: means for reading locker identifying information that is previously stored on the computer and is identification information inherent in the locker to output the information to the portable key apparatus during locking the locker; means for receiving key identifying information inherent in the portable key apparatus from the portable key apparatus to store the information on a memory of the computer during locking the locker; and means for storing the key identifying information previously stored on the portable key apparatus and the locker identifying information stored during locking the locker that are output from the portable key apparatus on the computer, for checking the output information with the key identifying information stored and the locker identifying information previously stored on the computer of the locker, and deciding the adequacy of unlocking of the locker based on the checked result.

The summary of the invention does not necessarily describe all necessary features of the present invention. The present invention may also be a sub-combination of the features described above.

### BRIEF DESCRIPTION OF THE DRAWINGS

FIG. 1 is a block diagram showing a configuration of a locker system that is an embodiment of the present invention.

FIG. 2 shows a schematic diagram explaining an example of use of the locker system.

FIG. 3 shows a front view of a locking and unlocking apparatus.

FIG. 4 is a sectional view of the locking and unlocking apparatus taken on line A-A in FIG. 3.

FIG. 5 shows a rear view of the locking and unlocking apparatus.

FIG. 6 shows a functional block diagram of the locking and unlocking apparatus.

FIG. 7 shows a top view of a portable key apparatus.

FIG. 8 shows a front view of the portable key apparatus.

FIG. 9 is a schematic sectional view of a main body of the portable key apparatus taken on line B-B in FIG. 7.

FIG. 10 shows a schematic sectional view when the main body is inserted into a holding section of the locking and unlocking apparatus.

FIG. 11 shows a functional block diagram of a transponder.

FIG. 12 shows a sectional view of the holding section in accordance with the main body of the portable key apparatus.

FIG. 13 shows a schematic plan view explaining a configuration of a stopper blocker.

FIG. 14 is a sectional view showing the condition that the main body of the portable key apparatus has been inserted into the holding section.

FIG. 15 is a block diagram showing a substantial part of a configuration of an administrative computer.

FIG. 16 is a table showing data configuration of a locker-using-information storing unit.

FIG. 17 is a flowchart showing an operation flow of the locking and unlocking apparatus and the portable key apparatus when locking the locker.

FIG. 18 is a flowchart showing a continuance of FIG. 17.

FIG. 19 is a flowchart showing an operation flow of the locking and unlocking apparatus and the portable key apparatus when unlocking the locker.

FIG. 20 is a flowchart showing a continuance of FIG. 19.

FIG. 21 is a flowchart showing another example of the continuance of FIG. 19.

FIG. 22 is a functional block diagram showing an alternative embodiment of the locking and unlocking apparatus.

FIG. 23 is a functional block diagram showing an alternative embodiment of the transponder.

FIG. 24 is a functional block diagram showing another alternative embodiment of the locking and unlocking apparatus.

FIG. 25 is a functional block diagram showing another alternative embodiment of the transponder.

FIG. 26 is a functional block diagram showing another alternative embodiment of the transponder.

### DETAILED DESCRIPTION OF THE INVENTION

Hereinafter, an example of the preferred embodiment of the present invention will be explained with reference to the accompanying drawings.

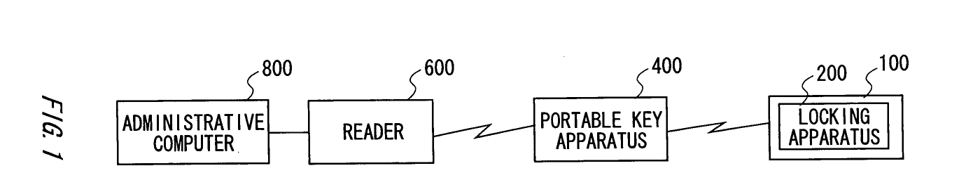

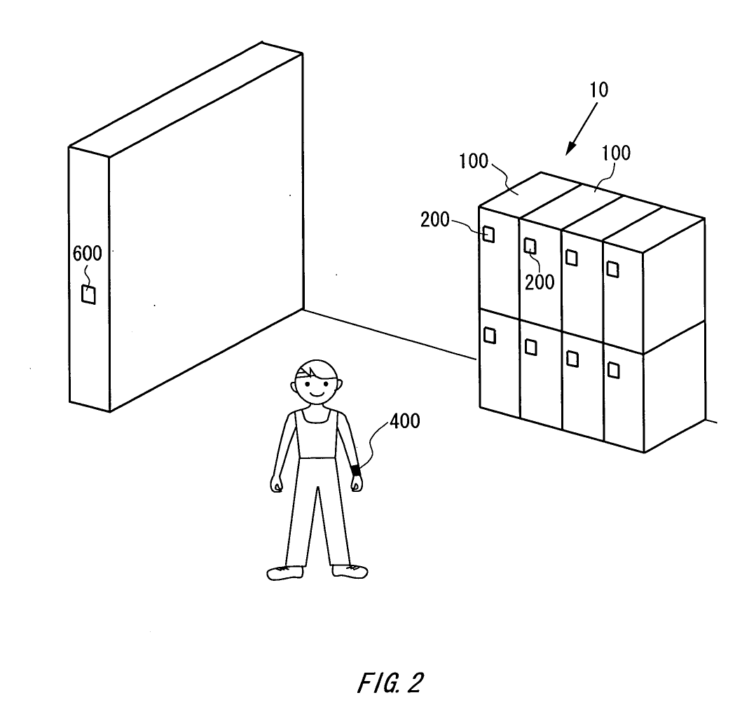

At first, a configuration of a locker system that is an embodiment of the present invention is described using FIGS. 1 and 2. FIG. 1 is a block diagram showing a configuration of the locker system, and FIG. 2 shows a schematic diagram explaining an example of use of the locker system.

This locker system includes a locker 100, a portable key apparatus 400, a reader 600, and an administrative computer 800 as shown in FIG. 1. In this locker system, the locker 100 is locked and unlocked based on electronic information that is communicated between the portable key apparatus 400 carried by a user and the locker 100 by radio.

The locker 100 has a locking and unlocking apparatus 200 that is provided on its door and performs locking and unlocking of the locker 100. Then, locker identifying information to distinguish the locking and unlocking apparatus 200 of the locker 100 from the locking and unlocking apparatus 200 of the other locker 100 is stored on the locking and unlocking apparatus 200. Moreover, key identifying information to distinguish the portable key apparatus 400 and the other portable key apparatus 400 is stored on the portable key apparatus 400.

An inherent key number is display on the surface of the portable key apparatus 400. Moreover, the administrative computer 800 is installed in, e.g., a front desk or a control room of a sports facility.

Then, the portable key apparatus 400 is a key for rent and is handed to the user, e.g., at the front desk of the sports facility. At this time, a receptionist at the front desk inputs the key number of portable key apparatus 400 to the administrative computer 800 using a keyboard input apparatus in association with user identifying information (e.g., user ID) of the user to whom this portable key apparatus 400 is handed.

The administrative computer 800 previously stores the key number and key identifying information on the portable key apparatus 400 in association with each other. Thus, based on the input key number, the key identifying information and the user identifying information are stored in association with each other.

In addition, a reader that communicates with the portable key apparatus 400 by radio may be installed in the front desk. In this case, the receptionist at the front desk causes the reader to read the key identifying information from the portable key apparatus 400. The reader stores the read key identifying information on the administrative computer 800 in association with the user identifying information input from the keyboard input apparatus or this reader.

Moreover, as shown in FIG. 2, the locker 100 is installed in, e.g., a locker room of the sports facility in the form of a locker box 10 that is collective of a plurality of lockers 100. Moreover, the portable key apparatus 400 is carried with the user and the reader 600 is installed in a doorway of the locker room.

When the user enters the locker room, the user selects and uses an arbitrary unused locker 100. Then, when locking the selected locker 100, the user inserts and rotates the portable key apparatus 400 into the locking and unlocking apparatus 200.

At this time, the key identifying information on the portable key apparatus 400 is transmitted to the locking and unlocking apparatus 200 and is stored on the locking and unlocking apparatus 200. Moreover, the locker identifying information on the locking and unlocking apparatus 200 is transmitted to the portable key apparatus 400 and is stored on the portable key apparatus 400.

Then, when unlocking the locker 100 which is used before, the user inserts the portable key apparatus 400 into the locking and unlocking apparatus 200.

At this time, the portable key apparatus 400 outputs the previously stored key identifying information and the locker identifying information stored during locking the locker to the locking and unlocking apparatus 200. The locking and unlocking apparatus 200 checks the key identifying information and the locker identifying information received from the portable key apparatus 400 during unlocking the locker with the key identifying information stored during locking the locker and the previously stored locker identifying information. Then, the locking and unlocking apparatus 200 determines adequacy of unlocking of the portable key apparatus 400 based on the checked result. When it is determined that the locking and unlocking apparatus 200 may be unlocked, the portable key apparatus 400 can be rotated. Then, the user unlocks the locker by rotating the portable key apparatus 400.

In other words, the user inserts and rotates the portable key apparatus 400 for rent that is handed at the front desk into the locking and unlocking apparatus 200 of the unused locker 100 that is selected in the locker room. Therefore, it is possible to use an arbitrary locker 100 selected in the locker room.

Moreover, after locking the locker 100, the user brings the portable key apparatus 400 close to the reader 600. The reader 600 reads a pair of the key identifying information stored on the portable key apparatus 400 and the locker identifying information received from the locker 100 during locking the locker by radio, and transmits the pair to the administrative computer 800 to store the pair thereon. In other words, according to this locker system, the locker identifying information can correspond to the user identifying information based on the key identifying information. Therefore, it is possible to acquire locker use information indicating who (e.g., a member of the sports facility) is using what locker.

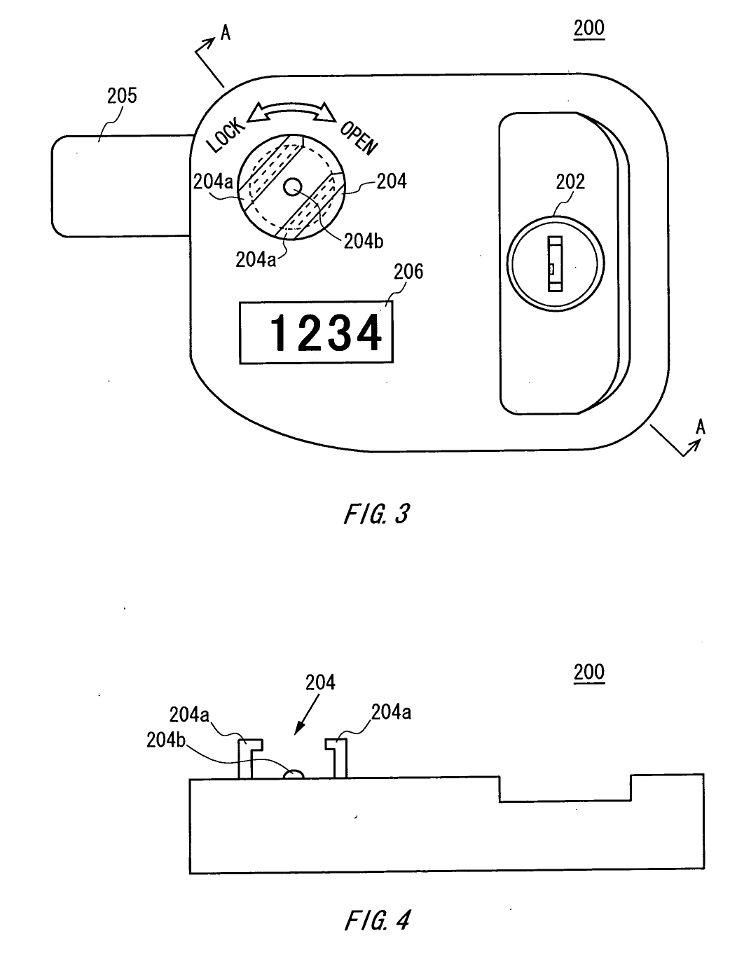

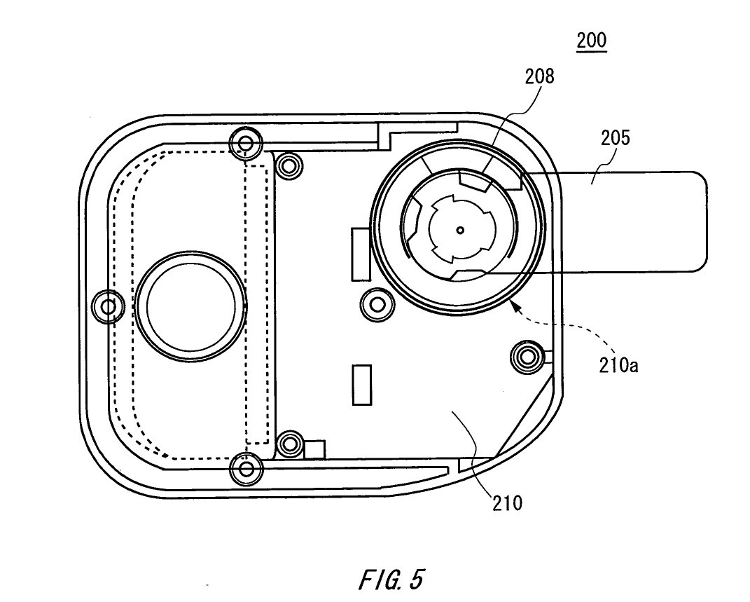

A configuration and function of the locking and unlocking apparatus 200 will be described with reference to FIGS. 3, 4, 5 and 6. FIG. 3 shows a front view of the locking and unlocking apparatus 200. FIG. 4 is a sectional view of the locking and unlocking apparatus 200 taken on line A-A in FIG. 3. FIG. 5 shows a rear view of the locking and unlocking apparatus 200. In addition, in FIGS. 3, 4 and 5, a part of members will not be shown.

As shown in FIG. 3, the locking and unlocking apparatus 200 has a master key inserting section 202, a holding section 204 that positions and holds the portable key apparatus 400, a locking lever 205 that turns to lock the door of locker 100, and a displaying section 206 that displays the locker identifying information, on the front. The holding section 204 is an example of a movable mechanism.

Moreover, as shown in FIG. 5, the locking and unlocking apparatus 200 has a control substrate 210 including a circuit for controlling the locking and unlocking apparatus 200 and an antenna 208 for communication with the portable key apparatus 400.

The master key inserting section 202 is a portion to insert a master key that is a mechanical key common to all locking and unlocking apparatuses 200. By turning the master key, the master key inserting section 202 is rotated along with the locking lever 205 by means of a mechanism not shown to unlocking the locking and unlocking apparatus 200.

The holding section 204 has the substantially same configuration as a cylinder lock, i.e., the locking lever 205 is attached in an inner cylinder. In other words, the locking and unlocking of the locker are performed by rotating the inner cylinder. Then, as shown in FIG. 3, a portion corresponding to a surface of the inner cylinder of the cylinder lock has two guides 204a and 204a and a rod-like stopper 204b in which its end is provided to come and go.

The guide 204a has a guide for allowing the insertion of the portable key apparatus 400 by sliding the portable key apparatus 400 in a planar direction and a mechanism of holding the inserted portable key apparatus 400. The cross sectional shape of the guide 204a is a generally reversed L shape as shown in FIG. 4. The guides 204a face each other. Then, a space, of which a cross section has a generally reversed T shape, is formed between two guides 204a. By rotating the portable key apparatus 400 inserted into the space between two guides 204a and 204a, the holding section 204 rotates along with the locking lever 205 to lock or unlock the locking and unlocking apparatus 200.

The rod-like stopper 204b is urged toward the surface of the holding section 204, and is engaged with the portable key apparatus 400 inserted between two guides 204a and 204a by means of this urging force. Here, the rod-like stopper 204b cannot temporarily retract based on control from the circuit included in the control substrate 210. In other words, the portable key apparatus 400 is temporarily fixed to the holding section 204. An operation of the rod-like stopper 204b will below be described in great detail.

The control substrate 210 has a generally circular opening section 210a for inserting the holding section 204 in a portion overlapped in a direction parallel to the holding section 204 as shown in FIG. 5. Then, a periphery of the opening section 210a has an antenna 208 surrounding the holding section 204. It is preferable that the antenna 208 is circular. Since the antenna 208 takes this disposition, the relative position of the portable key apparatus 400 temporarily fixed to the holding section 204 and the antenna is a location capable of favorably communicating with each other.

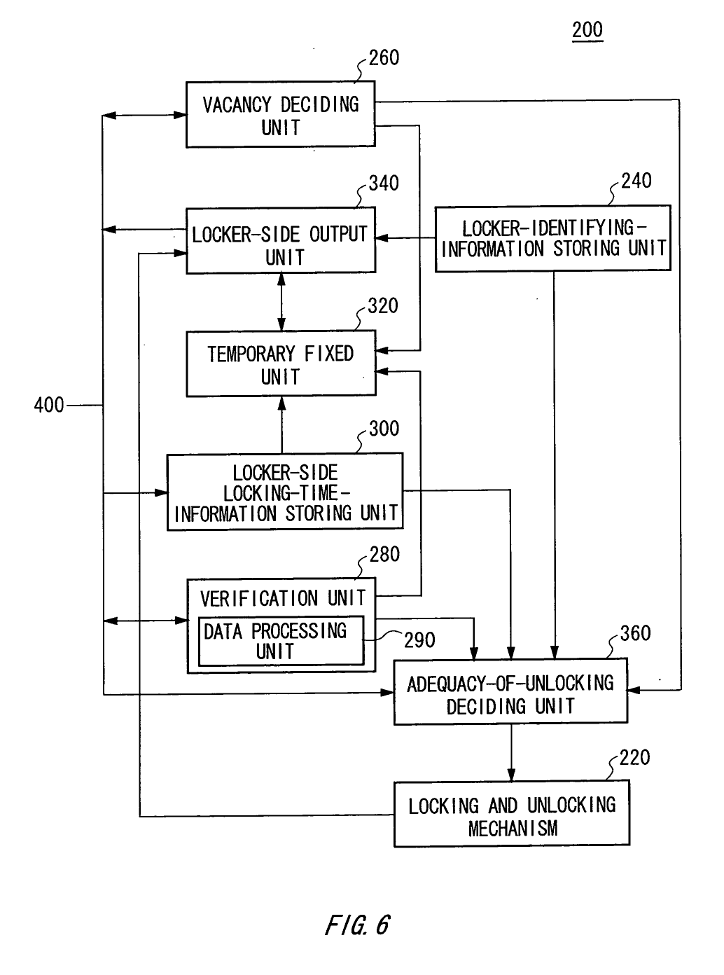

FIG. 6 shows a functional block diagram of the locking and unlocking apparatus 200. The locking and unlocking apparatus 200 includes a locking and unlocking mechanism 220, a locker-identifying-information storing unit 240, a vacancy deciding unit 260, a verification unit 280, a locker-side locking-time-information storing unit 300, a temporary fixed unit 320, a locker-side output unit 340, and an adequacy-of-unlocking deciding unit 360. The verification unit 280 includes a data processing unit 290.

The locking and unlocking mechanism 220 is a mechanism for enabling or disenabling one to open the door of locker 100, and the holding section 204 and the locking lever 205 shown in FIGS. 3 and 5 make up a part thereof. Although the locking and unlocking mechanism 220 moves by turning the portable key apparatus 400 that is inserted by the user into the holding section 204, the locking and unlocking mechanism 220 can move only when the adequacy-of-unlocking deciding unit 360 decides that the locker is able to be locked or unlocked.

The locker-identifying-information storing unit 240 previously stores the locker identifying information with which the locker 100 having this locking and unlocking apparatus 200 is identified.

The vacancy deciding unit 260 communicates with the portable key apparatus 400 to confirm that the portable key apparatus 400 does not store the locker identifying information on the other locker 100. Then, when it is confirmed, it is determined that the portable key apparatus 400 has not been used yet used for the other locker 100.

The verification unit 280 outputs data for processing generated at random on the moment to the portable key apparatus 400 during locking and unlocking the locker, respectively. Moreover, the verification unit 280 stores the output data for processing during locking and unlocking the locker, respectively. Then, the verification unit 280 receives authentication data generated by the portable key apparatus 400 based on the data for processing from the portable key apparatus 400. Then, the verification unit 280 checks the received authentication data and the stored data for processing using the data processing unit 290, and verifies whether the portable key apparatus 400 is a normal product. The operations of verification will be described below by means of the flowchart.

The locker-side locking-time-information storing unit 300 receives the key identifying information on this portable key apparatus 400 from the portable key apparatus 400 inserted into the holding section 204 to store it thereon.

The temporary fixed unit 320 temporarily fixes the portable key apparatus 400 inserted into the holding section 204 so as not to get removed from the holding section 204 when it is determined that the portable key apparatus 400 has not been used for the other locker 100 and it is authenticated that the portable key apparatus 400 is a regular article. The rod-like stopper 204b shown in FIG. 3 makes up a part of the temporary fixed unit 320.

The locker-side output unit 340 reads the locker identifying information from the locker-identifying-information storing unit 240 and transmits it to the portable key apparatus 400 on condition that the temporary fixed unit 320 temporarily fixes the portable key apparatus 400 and the locking and unlocking mechanism 220 has been locked completely.

Then, the temporary fixed unit 320 enables the portable key apparatus 400 inserted into the holding section 204 so as to get removed from the holding section 204 on condition that the locking and unlocking mechanism 220 is locked completely, the locker-side locking-time-information storing unit 300 completely stores the key identifying information, and the locker-side output unit 340 completely outputs the locker identifying information to cause the portable key apparatus 400 to store it.

The adequacy-of-unlocking deciding unit 360 enables to lock the locking and unlocking mechanism 220 when the portable key apparatus 400 is a normal product and does not store the other locker identifying information.

Moreover, the adequacy-of-unlocking deciding unit 360 receives the key identifying information stored on the portable key apparatus 400 and the locker identifying information that the portable key apparatus 400 receives and stores from the locking and unlocking apparatus 200 during locking the locker, from the portable key apparatus 400 during unlocking the locker. Then, when the portable key apparatus 400 is a normal product and the key identifying information and the locker identifying information received during unlocking the locker respectively corresponds with the key identifying information stored on the locker-side locking-time-information storing unit 300 and the locker identifying information previously stored on the locker-identifying-information storing unit 240, the locking and unlocking mechanism 220 can be unlocked.

Therefore, by an operation of the verification unit 280, the locking and unlocking apparatus 200 can allow locking or unlocking of the locker on condition that the portable key apparatus 400 is a normal product. Moreover, by an operation of the temporary fixed unit 320, the locking and unlocking apparatus 200 can prevent the user from pulling out the portable key apparatus 400 from the holding section 204 before finishing exchanging the locker identifying information and the key identifying information.

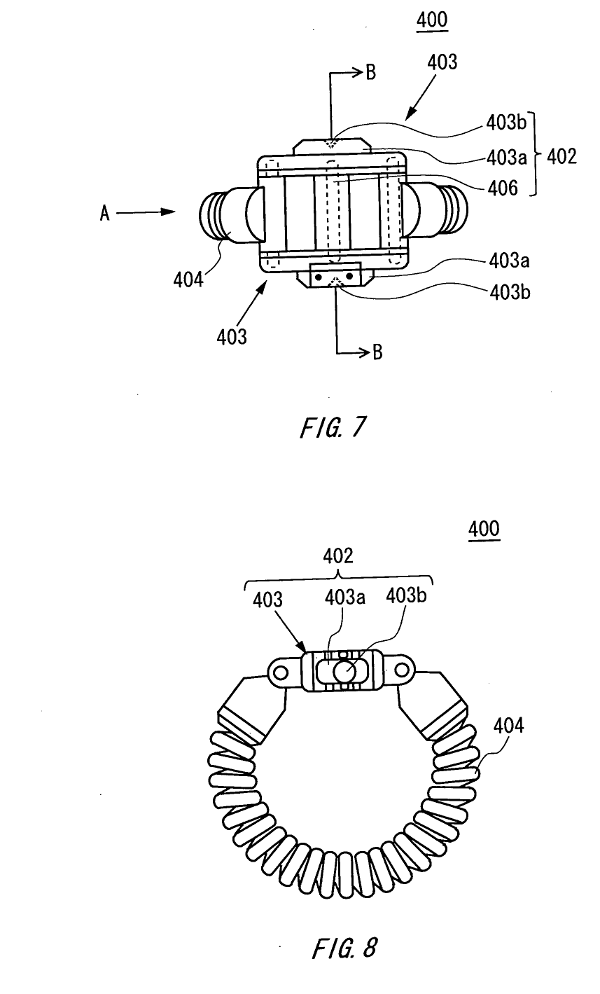

Next, a configuration and function of the portable key apparatus 400 will be described with reference to FIGS. 7, 8, 9, 10 and 11.

FIG. 7 shows a top view of the portable key apparatus 400. FIG. 8 shows a front view of the portable key apparatus 400. The portable key apparatus 400 has a main body 402 having a transponder 406 for executing many functions of the portable key apparatus 400 built-in and a curl-cord-shaped attaching mechanism 404 for attaching the main body 402 to the wrist. In addition, the attaching mechanism 404 may be a wristband. Moreover, the transponder 406 employs glass sealing when corrosion resistance and water resistance property are required.

The main body 402 is a thin and substantially rectangular solid shape, and has the substantially same size as that of, e.g., a main body of a wristwatch. Here, both ends of the attaching mechanism 404 are respectively fixed to side faces facing each other. Moreover, each of remaining two side faces has engaging sections 403 to engage with two guides 204a and 204a of the holding section 204.

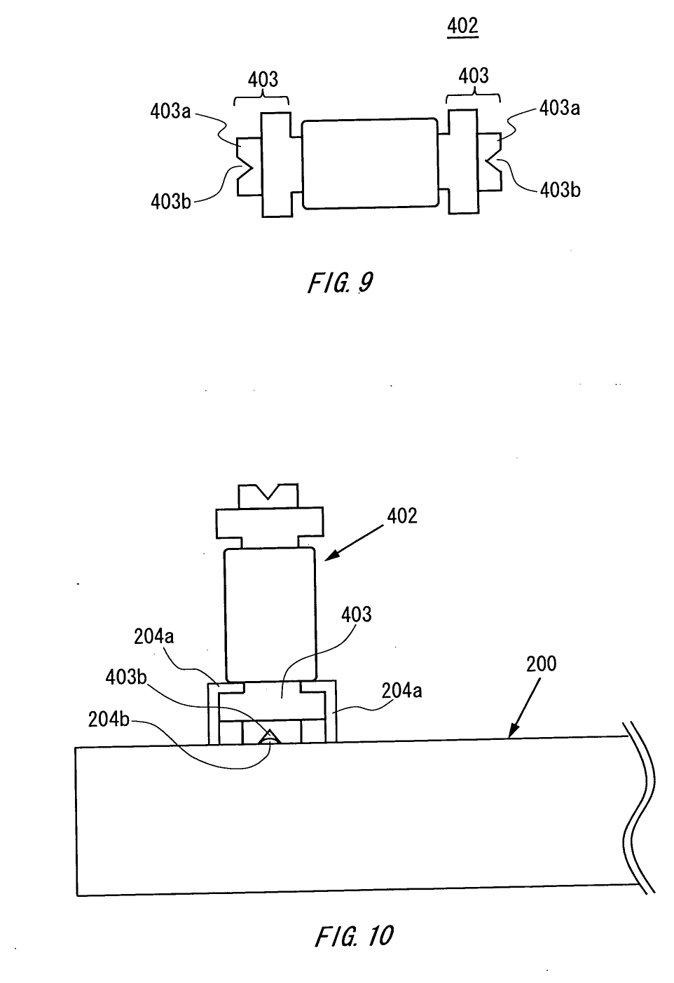

FIG. 9 is a schematic sectional view of the main body 402 of the portable key apparatus 400 taken on line B-B in FIG. 7. In the present drawing, an internal configuration of the main body 402 will not be shown. The cross sectional shape of engaging section 403 is, e.g., generally T type except a convex portion 403a as shown in FIG. 9.

Furthermore, the engaging section 403 has the convex portion 403a. When sliding the main body 402, the convex portion 403a pushes the rod-like stopper 204b temporarily. Moreover, the convex portion 403a includes a concave portion 403b near its center. An inner wall of the concave portion 403b is a shape of a taper.

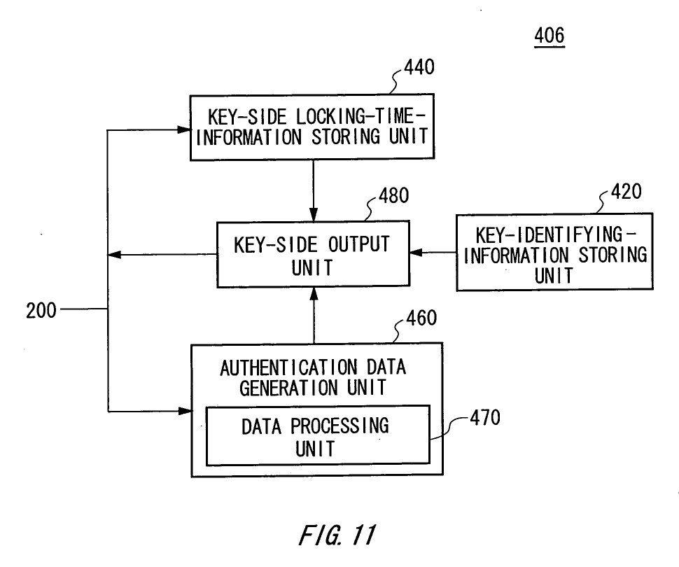

Here, the condition that the main body 402 of the portable key apparatus 400 is inserted into the holding section 204 of the locking and unlocking apparatus 200 will be described using the schematic sectional view of FIG. 10.

The portion of generally T type of the engaging section 403 fits in a space of generally reverse T type that the two guides 204a of the holding section 204 form. For this reason, the main body 402 fitted between the two guides 204a cannot be removed from the holding section 204 unless the main body 402 is slid in a planar direction.

Moreover, after the rod-like stopper 204b is temporarily pushed by the convex portion 403a, the rod-like stopper 204b is fitted in the concave portion 403b.

In addition, since the inner wall of the concave portion 403b is a shape of a taper, the rod-like stopper 204b is smoothly pushed back to the surface side when sliding the main body 402 from the condition of FIG. 10.

FIG. 11 shows a functional block diagram of the transponder 406. The transponder 406 has a key-identifying-information storing unit 420, a key-side locking-time-information storing unit 440, an authentication data generation unit 460, and a key-side output unit 480. The authentication data generation unit 460 includes a data processing unit 470.

The key-identifying-information storing unit 420 stores the key identifying information on this portable key apparatus 400. The key-side locking-time-information storing unit 440 stores the locker identifying information that the transponder 406 receives from the locking and unlocking apparatus 200 during locking the locker. The authentication data generation unit 460 processes the data for processing received from the verification unit 280 of the locking and unlocking apparatus 200 to generate the authentication data using the data processing unit 470.

The key-side outputting unit 480 outputs the authentication data generated from the authentication data generation unit 460 to the locking and unlocking apparatus 200 during locking the locker. Then, the key-side outputting unit 480 outputs the key identifying information stored on the key-identifying-information storing unit 420 to the locking and unlocking apparatus 200 according to a request from the locking and unlocking apparatus 200. Here, the key-side outputting unit 480 may output the key identifying information on condition that the key-side locking-time-information storing unit 440 stored the locker identifying information.

Moreover, the key-side output unit 480 outputs the authentication data generated from the authentication data generation unit 460 to the locking and unlocking apparatus 200 during unlocking the locker. Then, the key-side output unit 480 outputs the key identifying information stored on the key-identifying-information storing unit 420 and the locker identifying information stored on the key-side locking-time-information storing unit 440 during locking the locker to the locking and unlocking apparatus 200 according to a request from the locking and unlocking apparatus 200.

Therefore, when the portable key apparatus 400 is used for the locker 100, the portable key apparatus 400 is used as a dedicated key for that locker 100 by storing the locker identifying information. Moreover, by transmission of the authentication data, it is possible to cause the locking and unlocking apparatus 200 to authenticate whether the portable key apparatus is a normal product.

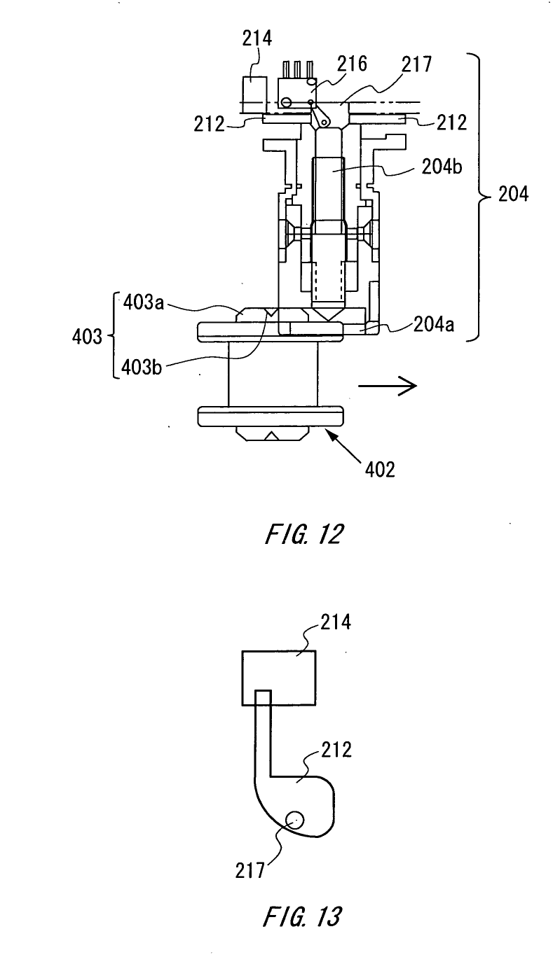

Next, a mechanism and operation of the temporary fixed unit 320 of the locking and unlocking apparatus 200 will be described with reference to FIGS. 12, 13 and 14.

FIG. 12 shows a sectional view of the holding section 204 in accordance with the main body 402 of the portable key apparatus 400. According to the drawing, the main body 402 is inserted between the two guides 204a of the holding section 204.

The holding section 204 includes a plate-like stopper blocker 212 provided vertically to the rod-like stopper 204b, a drive means that moves the stopper blocker 212 in a direction perpendicular to the rod-like stopper 204b, and a switch 216 that is positioned to face the rod-like stopper 204b holding the stopper blocker 212 therebetween.

Here, a structure of the stopper blocker 212 will be explained by means of the schematic plan view shown in FIG. 13. In the stopper blocker 212, its end is attached to the drive means 214. Moreover, the stopper blocker 212 has a substantially circular opening section 217 for inserting the rod-like stopper 204b. The diameter of the opening section 217 is slightly larger than the outer diameter of the rod-like stopper 204b, and inserts the stopper blocker 212 only when the stopper blocker 212 is at a specific position.

In other words, the stopper blocker 212 is at a position at which the stopper blocker 212 is inserted into the opening section 217 in initial status, i.e., the state depicted in FIG. 12.

In this state, when further sliding the main body 402 of the portable key apparatus 400 along the guide 204a of the locking and unlocking apparatus 200, the rod-like stopper 204b is pushed in contact with the convex portion 403a of the main body 402. At this time, the rod-like stopper 204b pushes the switch 216.

When the switch 216 is pushed, the drive means 214 applies a force to move the stopper blocker 212 in a direction perpendicular to the rod-like stopper 204b. However, at this time, since the rod-like stopper 204b inserts the opening section 217, the stopper blocker 212 cannot move.

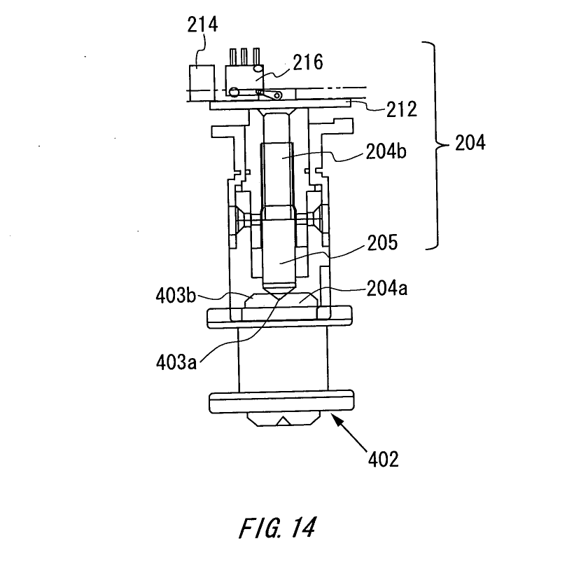

Then, when the main body 402 slides sufficiently and the concave portion 403b comes to a position at which it over laps the rod-like stopper 204b as shown in FIG. 14, the rod-like stopper 204b is pushed back by an urging means not shown in the surface direction to fit in the concave portion 403b. At this time, the rod-like stopper 204b is pulled up from the opening section 217. Then, the stopper blocker 212 moves by way of the force applied from the drive means 214, the opening section 217 comes to a position at which it does not overlap the rod-like stopper 204b.

In this state, the rod-like stopper 204b cannot be pushed due to bumping against the stopper blocker 212 and fits in the concave portion 403b. Therefore, the main body 402 is temporarily fixed to the holding section 204 by means of the rod-like stopper 204b.

Then, when the locking operation or the unlocking operation is terminated, the drive means 214 returns the stopper blocker 212 to the initial state, and moves the opening section 217 at a position at which it can insert the rod-like stopper 204b. In this way, the main body 402 fixed temporarily can be removed from the holding section 204.

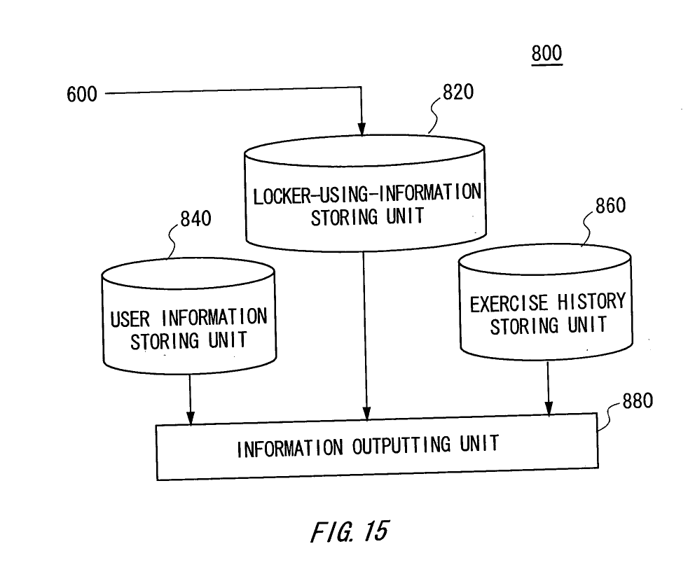

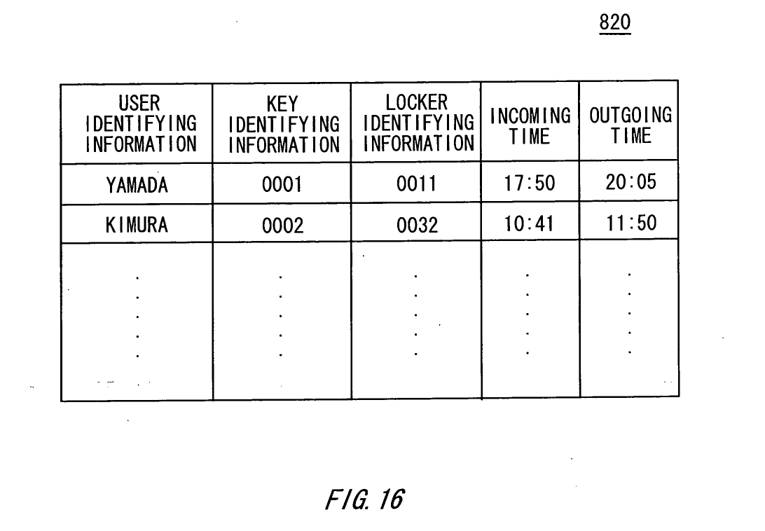

Next, a configuration of the administrative computer 800 will be described with reference to FIGS. 15 and 16. FIG. 15 is a block diagram showing a principal part of a configuration of the administrative computer 800. The administrative computer 800 has a locker-using-information storing unit 820 for storing a locker using history, a user information storing unit 840 for storing detailed information on the user, a exercise history storing unit 860 for storing an exercise history of the user, and an information outputting unit 880 for outputting the information stored in the administrative computer 800 to a printer or a screen.

The locker-using-information storing unit 820 previously stores the user identifying information and the key identifying information in association with each other as shown in a table in FIG. 16. This pair is input to the locker-using-information storing unit 820 by a receptionist when the portable key apparatus 400 is handed to the user, e.g., at the reception desk of sports facility. In this case, the locker-using-information storing unit 820 stores the handed time as an incoming time of the facility and stores a time at which the portable key apparatus 400 is returned as an outgoing time from the facility.

Then, the locker-using-information storing unit 820 receives the key identifying information and the locker identifying information that the reader 600 reads from the portable key apparatus 400, and stores the locker identifying information and the user identifying information in association with each other based on the key identifying information. In addition, the locker-using-information storing unit 820 may store a time at which the key identifying information and the locker identification information are received as the incoming time.

Moreover, the user information storing unit 840 previously stores detailed information on the user such as a full name, an address, a telephone number, an occupation, sex distinction of the user in association with the user identifying information. Therefore, the information outputting unit 880 can output the detailed information on the user such as the locker identifying information and the full name of the user in association with each other based on the user identifying information.

Moreover, the exercise history storing unit 860 stores an exercise history of the user in the facility in association with the user identifying information. Therefore, the information outputting unit 880 can output the locker using history and the exercise history in association with each other based on the user identifying information.

In addition, the exercise history is recorded, e.g., according to the following steps. In other words, the reader 600 will respectively be installed in the entrance of the space in which the user takes exercise such as a swimming pool or a fitness room. The administrative computer 800 receives the key identifying information read by the reader 600 in association with information to specify installation location of the reader 600. Then, the administrative computer 800 converts the key identifying information into the user identifying information, and stores the converted information on the exercise history storing unit 860 in association with the information to specify installation location of the reader 600 and the received time.

In this way, it is possible to manage the location of the user in the facility besides the exercise history.

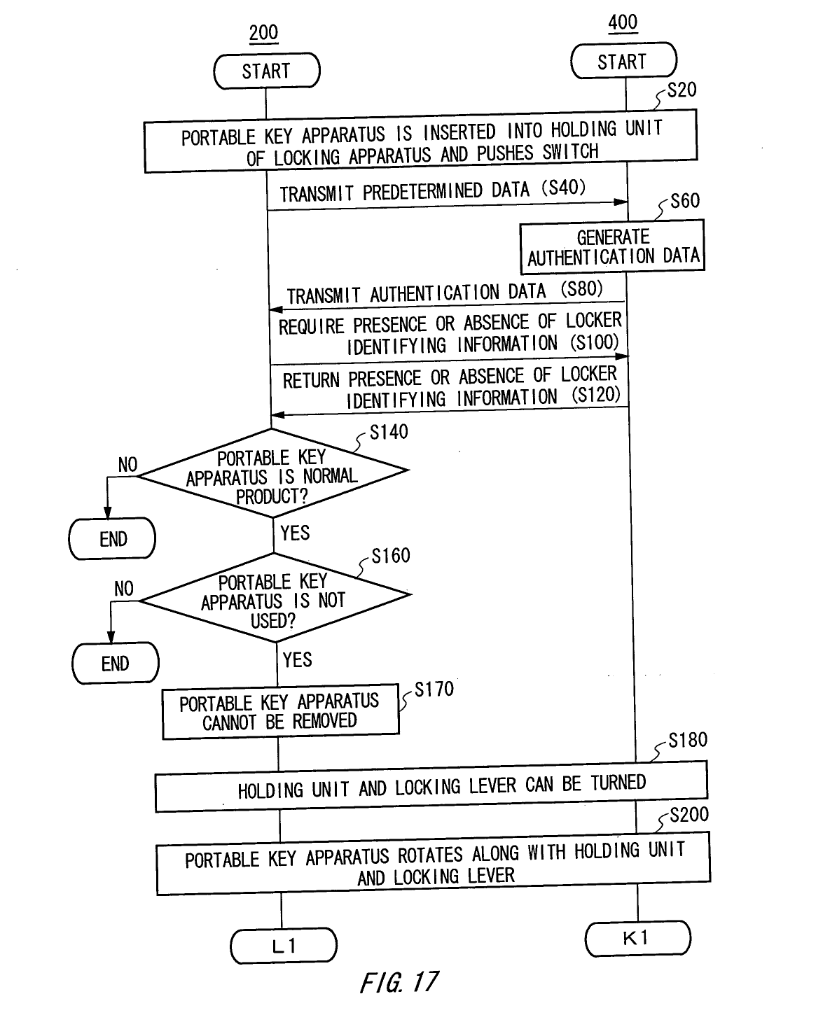

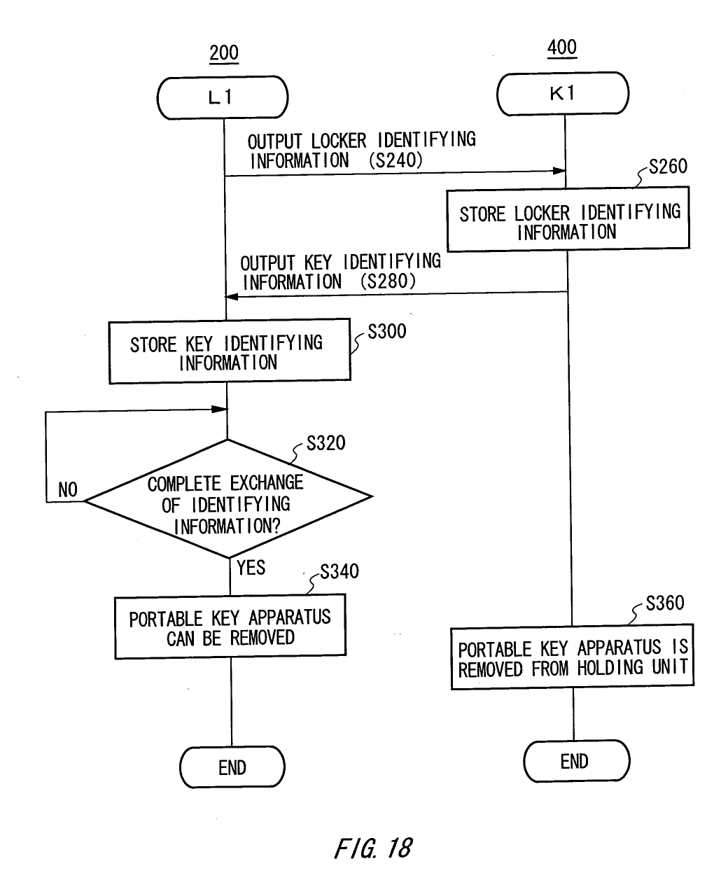

Next, using flowcharts shown in FIGS. 17 and 18, an operation flow of the locking and unlocking apparatus 200 and the portable key apparatus 400 when locking the locker 100 will be described. At first, the user selects the unused locker 100. Then, the user puts a load in the selected locker 100 and closes the door.

Then, the user inserts the main body 402 of the portable key apparatus 400 into the holding section 204. At this time, the main body 402 slides over the surface of the holding section 204 from a lower-left edge toward an upper right of FIG. 3. Here, the main body 402 pushes the switch 216 shown in FIGS. 12 and 14 on the way (S20).

Then, the verification unit 280 of the locking and unlocking apparatus 200 transmits data for processing that is a predetermined data to the portable key apparatus 400 (S40). The data for processing is generated as random numbers of predefined digits namely a digit sequence by way of, e.g., a random number generating means included in the verification unit 280. Here, the verification unit 280 stores the data for processing as it is.

The authentication data generating unit 460 of the portable key apparatus 400 processes the data for processing transmitted from the verification unit 280 using the data processing unit 470 based on a predetermined rule to generate the authentication data (S60). This rule is encryption in which a character string and a digit sequence of the data for processing can be reversed, or a part of a character string and a digit sequence of the data for processing can be omitted, for example. Then, the authentication data generating unit 460 transmits the generated authentication data to the verification unit 280 (S80).

Next, the vacancy deciding unit 260 of the locking and unlocking apparatus 200 asks the portable key apparatus 400 whether the portable key apparatus 400 previously stores the locker identifying information (S100). Then, the key-side output unit 480 of the portable key apparatus 400 reads and transmits the locker identifying information when the locker identifying information on the other locker is already stored on the key-identifying-information storing unit 420 and does not transmit anything when it is not stored in order to return the presence or absence of the storage of the locker identifying information (S120).

Then, the verification unit 280 processes the data for processing ago stored thereon using the data processing unit 290 by means of the same rule as that of S60, compares the processed data and the received authentication data, and verifies whether the portable key apparatus 400 is a normal product (S140).

In other words, the verification unit 280 authenticates that the portable key apparatus 400 is a normal product on condition that the data for processing transmitted therefrom has processed and returned based on the predetermined rule. Therefore, it is difficult to make an imitation of the portable key apparatus 400.

Then, it is confirmed that the portable key apparatus 400 is not used by confirming that the locker identifying information is not stored (S160: Yes).

After that, the temporary fixed unit 320 is temporarily fixed so that the portable key apparatus 400 does not removed from the holding section 204 (S170). Moreover, the holding section 204 and the locking lever 205 may be allowed to be turned by the adequacy-of-unlocking deciding unit 360 (S180).

Then, when the user turns the portable key apparatus 400, the portable key apparatus 400 rotates along with the holding section ˜204 and the locking lever 205. As a result, the locking and unlocking apparatus 200 locks the locker 100 (S200).

Referring to FIG. 18, when the locking is completed, the locker-side output unit 340 of the locking and unlocking apparatus 200 outputs the locker identifying information to the portable key apparatus 400 (S240).

The key-side locking-time-information storing unit 440 of the portable key apparatus 400 stores the received locker identifying information (S260). Then, the key-side output unit 480 outputs the key identifying information to the locking and unlocking apparatus 200 on condition that the locker identifying information has been stored completely (S280). The locker-side locking-time-information storing unit 300 of the locking and unlocking apparatus 200 stores the key identifying information received from the portable key apparatus 400 (S300).

Then, by completely storing the key identifying information, the temporary fixed unit 320 decides that the exchange of the locker identifying information and the key identifying information has been completed (S320). Therefore, although the portable key apparatus 400 does not independently notify the locking and unlocking apparatus 200 that the storage of the locker identifying information has been completed, the locking and unlocking apparatus 200 can know that the locker identifying information has been stored on the portable key apparatus 400 completely.

After that, the temporary fixed unit 320 causes the portable key apparatus 400 to be removed from the holding section 204 (S340). Then, the portable key apparatus 400 is removed from the holding section 204 by the user (S360). As described above, the locking act by the user is completed.

Therefore, a user can use the portable key apparatus 400 with the same sense as that of a mechanical key during locking the locker. In other words, the portable key apparatus 400 does not bother the user during locking the locker.

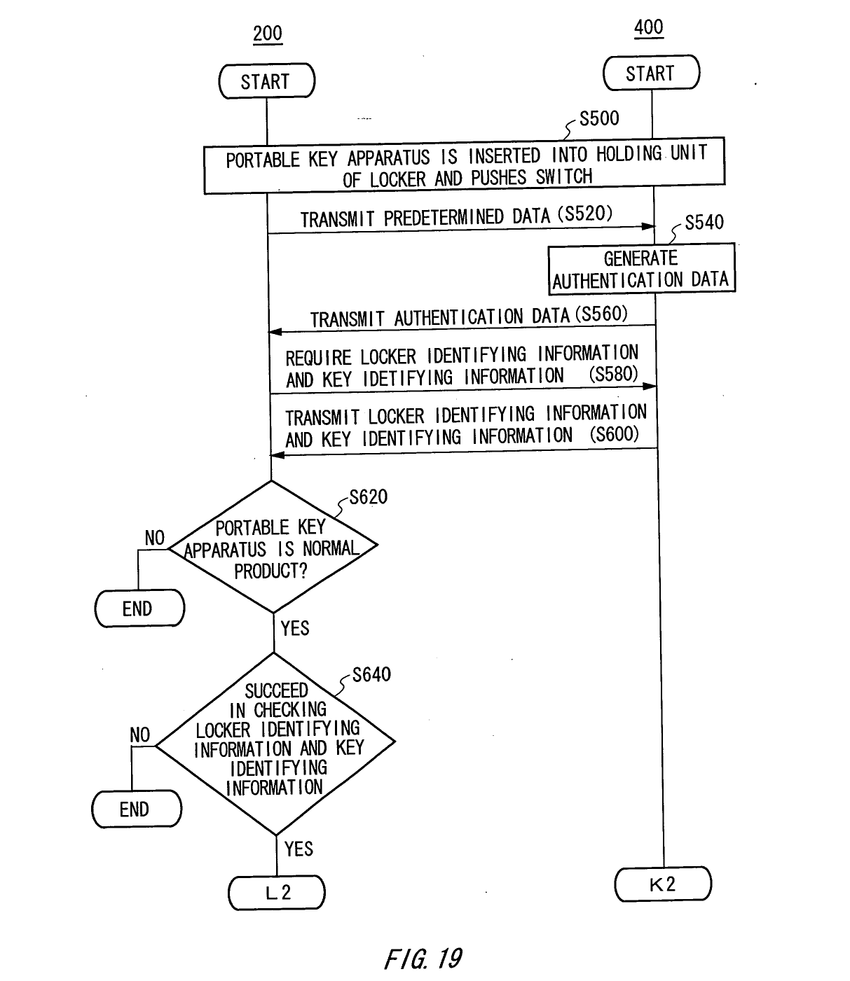

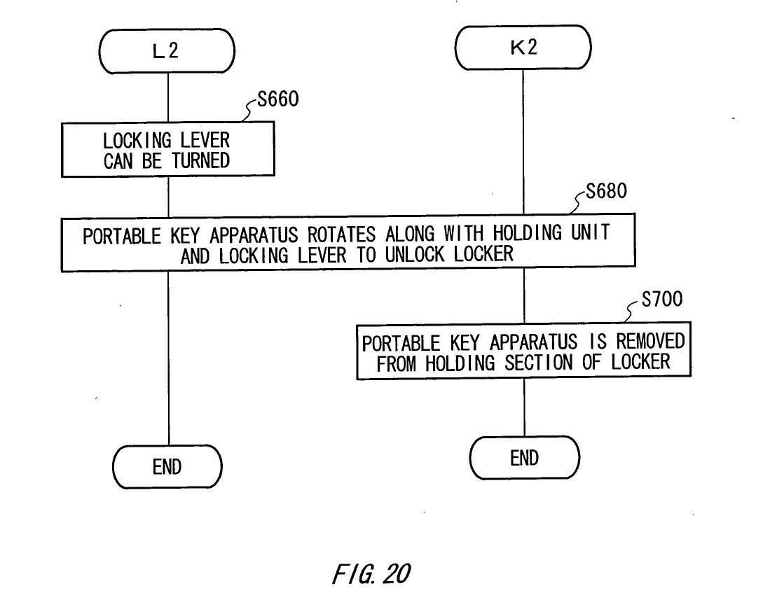

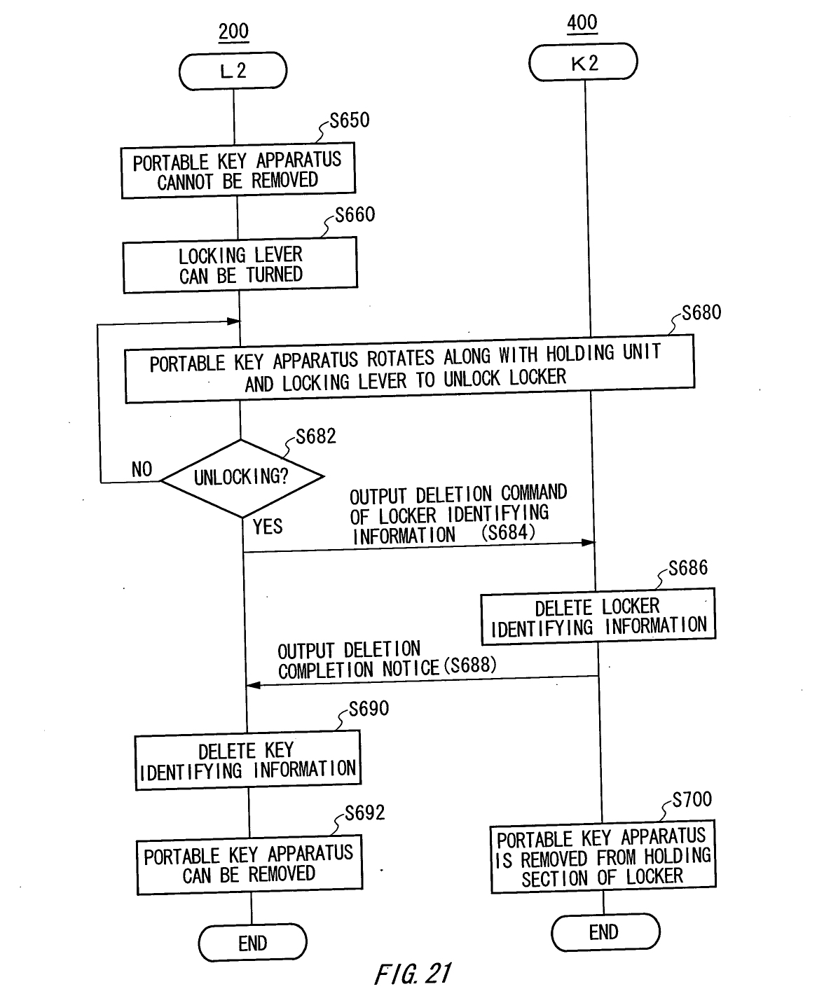

Next, using flowcharts shown in FIGS. 19 and 20, an operation flow of the locking and unlocking apparatus 200 and the portable key apparatus 400 when unlocking the locker 100 will be described. At first, the main body 402 of the portable key apparatus 400 slides to be inserted into the holding section 204 of the locking and unlocking apparatus 200. At this time, the switch 216 shown in FIGS. 12 and 14 is pushed (S500).

Then, the verification unit 280 of the locking and unlocking apparatus 200 transmits data for processing to the portable key apparatus 400 (S520). It is preferable that the data for processing is different from the data used during locking the locker. The data for processing is generated as random numbers of predefined digits namely a digit sequence by way of, e.g., the random number generating means included in the verification unit 280. Here, the verification unit 280 stores the received data for processing.

The authentication data generating unit 460 of the portable key apparatus 400 processes the data for processing transmitted from the verification unit 280 using the data processing unit 470 based on the predetermined rule just like S60 of FIG. 17 to generate the authentication data (S540). Then, the authentication data generating unit 460 transmits the generated authentication data to the verification unit 280 (S560).

Next, the vacancy deciding unit 260 of the locking and unlocking apparatus 200 requires the portable key apparatus 400 to send the locker identifying information and the key identifying information (S580). Then, the key-side output unit 480 of the portable key apparatus 400 transmits the locker identifying information that the key-identifying-information storing unit 420 receives and stores from the locking and unlocking apparatus 200 during locking the locker and the key identifying information previously stored on the key-identifying-information storing unit 420 to the locking and unlocking apparatus 200 (S600).

Then, the verification unit 280 performs the same process as that of S140 of FIG. 17 to verify whether the portable key apparatus is a normal product (S620).

After that, the adequacy-of-unlocking deciding unit 360 respectively checks the locker identifying information and the key identifying information received at the S600 with the locker identifying information previously stored on the locker-identifying-information storing unit 240 and the key identifying information stored on the locker-side locking-time-information storing unit 300, and verifies that the portable key apparatus 400 is the portable key apparatus 400 used during locking the locker on condition that each information corresponds to each other (step S640: Yes).

Referring to FIG. 20, the holding section 204 and the locking lever 205 can be turned in an unlocking direction by the adequacy-of-unlocking deciding unit 360 when it is decided that the portable key apparatus 400 is a normal product and is the portable key apparatus 400 used during locking the locker (S660).

Then, the portable key apparatus 400 rotates along with the holding section 204 and the locking lever 205 by turning the portable key apparatus 400 to an unlocking direction. As a result, the locker 100 is unlocked (S680).

After that, the portable key apparatus 400 is removed from the holding section 204 by the user (S700). As described above, the unlocking act by the user is completed.

Therefore, the user can use the portable key apparatus 400 as if he/she is using a mechanical key during unlocking the locker. In other words, the portable key apparatus 400 does not bother the user during unlocking the locker.

In addition, after the portable key apparatus 400 has been returned to the front desk of facility, the locker identifying information stored on the key-side locking-time-information storing unit 440 of the portable key apparatus 400 is deleted. In this way, the user cannot use the plurality of lockers 100. Moreover, since the locker identifying information is deleted at the front desk of facility, this portable key apparatus 400 can be handed to the next user.

In addition, the key identifying information stored on the locker-side locking-time-information storing unit 300 of the locking and unlocking apparatus 200 may be deleted on condition that the locker 100 has been unlocked or may be deleted when the locker is locked using new portable key apparatus 400.

Next, using flowcharts shown in FIG. 21, another example of an operation flow of the locking and unlocking apparatus 200 and the portable key apparatus 400 when unlocking the locker 100 will be described. In this operation flow, since initial operations of the locking and unlocking apparatus 200 and the portable key apparatus 400 are equal to those of FIG. 17, their descriptions will be omitted.

After the locking and unlocking apparatus 200 and the portable key apparatus 400 performs the operations as showed in FIG. 17, the temporary fixed unit 320 of the locking and unlocking apparatus 200 temporarily fixes the portable key apparatus 400 to be able to be removed from the holding section 204 (S650). Then, the adequacy-of-unlocking deciding unit 360 allows the holding section 204 and the locking lever 205 to rotate (S660).

Then, when the user turns the portable key apparatus 400, the portable key apparatus 400 rotates along with the holding section 204 and the locking lever 205. Thus, the locker 100 is unlocked (S680).

Then, the locker-side output unit 340 outputs a deletion command of the locker identifying information to the portable key apparatus 400 (S684) on condition that the unlocking of locker 100 has been completed (S682).

The key-side locking-time-information storing unit 440 of the portable key apparatus 400 deletes the stored locker identifying information (S686), and outputs the deletion completion notice to the temporary fixed unit 320 of the locking and unlocking apparatus 200 (S688). Then, the locker-side locking-time-information storing unit 300 of the locking and unlocking apparatus 200 deletes the stored key identifying information (S690).

After that, the portable key apparatus 400 can be allowed to be removed by the temporary fixed unit 320 (S692). Then, the user removes the portable key apparatus 400 from the holding section 204 (S700). In other words, the locking and unlocking apparatus 200 and the portable key apparatus 400 are initialized on the moment just after unlocking the locker. Therefore, the user can change the locker 100 to be used.

In addition, in the described embodiment, although the adequacy of unlocking is decided using both the locker identifying information and the key identifying information, the adequacy of unlocking may be decided using either of them as shown in next.

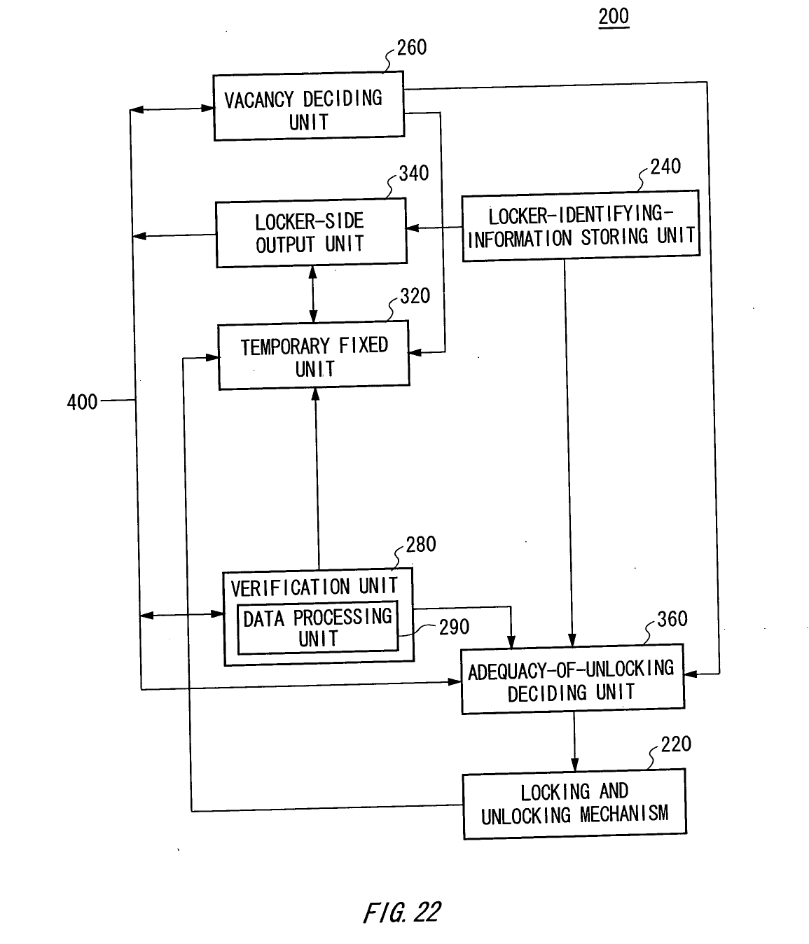

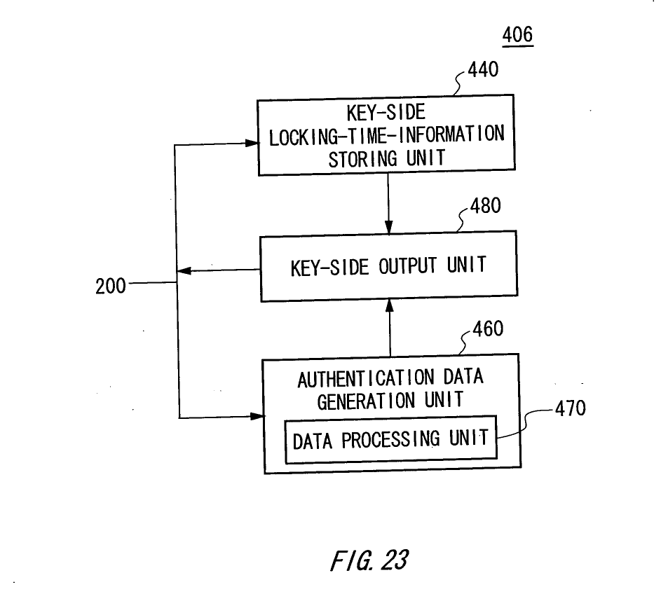

At first, using FIGS. 22 and 23, a configuration of the locking and unlocking apparatus 200 and the portable key apparatus 400 when deciding the adequacy of unlocking using only the locker identifying information will be explained. In this case, as shown in FIG. 22, the locking and unlocking apparatus 200 is different from that shown in FIG. 6 in that it does not include the locker-side locking-time-information storing unit 300. Moreover, as shown in FIG. 23, the portable key apparatus 400 is different from that shown in FIG. 11 in that it does not include the key-identifying-information storing unit 420 in relation to the function of the transponder 406.

In other words, during locking the locker, the locker identifying information is transmitted to the portable key apparatus 400 and is stored on the key-side locking-time-information storing unit 440 of the portable key apparatus 400. Then, during unlocking the locker, the locker identifying information stored on the key-side locking-time-information storing unit 440 is transmitted to the locking and unlocking apparatus 200. The adequacy-of-unlocking deciding unit 360 allows the locking and unlocking mechanism 220 to be unlocked when the transmitted locker identifying information corresponds to the locker identifying information stored on the locker-identifying-information storing unit 240.

In addition, since the other configuration, function, and operation are equal to those of the described embodiment, their descriptions will be omitted.

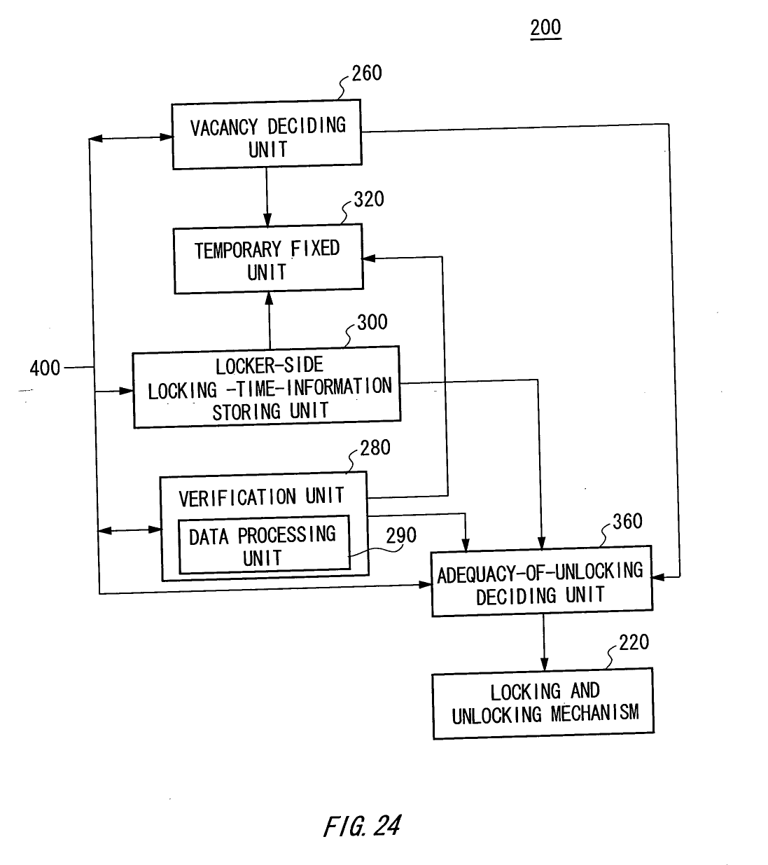

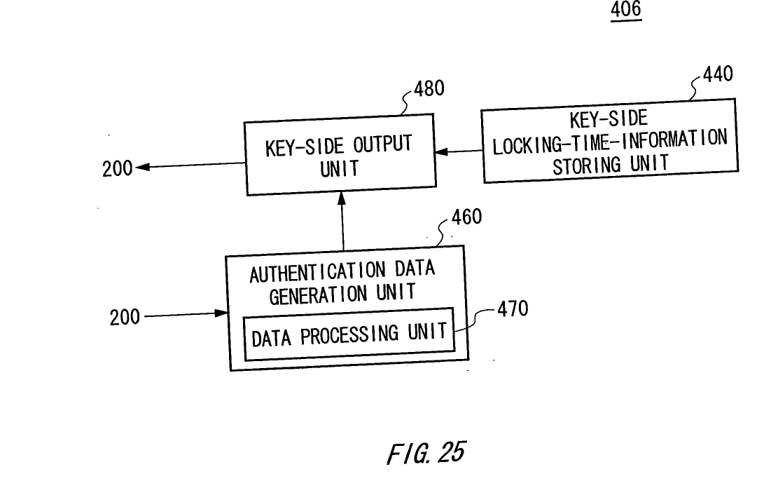

Next, using FIGS. 24 and 25, a configuration of the locking and unlocking apparatus 200 and the portable key apparatus 400 when deciding the adequacy of unlocking using only the key identifying information will be explained. In this case, as shown in FIG. 24, the locking and unlocking apparatus 200 is different from that shown in FIG. 6 in that it does not include the locker-identifying-information storing unit 240. Moreover, as shown in FIG. 25, the portable key apparatus 400 is different from that shown in FIG. 11 in that it does not have the key-identifying-information storing unit 420 in relation to the function of the transponder 406.

In other words, during locking the locker, the key identifying information is transmitted to the locking and unlocking apparatus 200 and is stored on the locker-side locking-time-information storing unit 300 of the locking and unlocking apparatus 200. Then, during unlocking the locker, the key identifying information stored on the key-identifying-information storing unit 420 is transmitted to the locking and unlocking apparatus 200. The adequacy-of-unlocking deciding unit 360 allows the locking and unlocking mechanism 220 to be unlocked when the transmitted key identifying information corresponds to the key identifying information stored on the locker-side locking-time-information storing unit 300.

In addition, since the other configuration, function, and operation are equal to those of the described embodiment, their descriptions will be omitted.

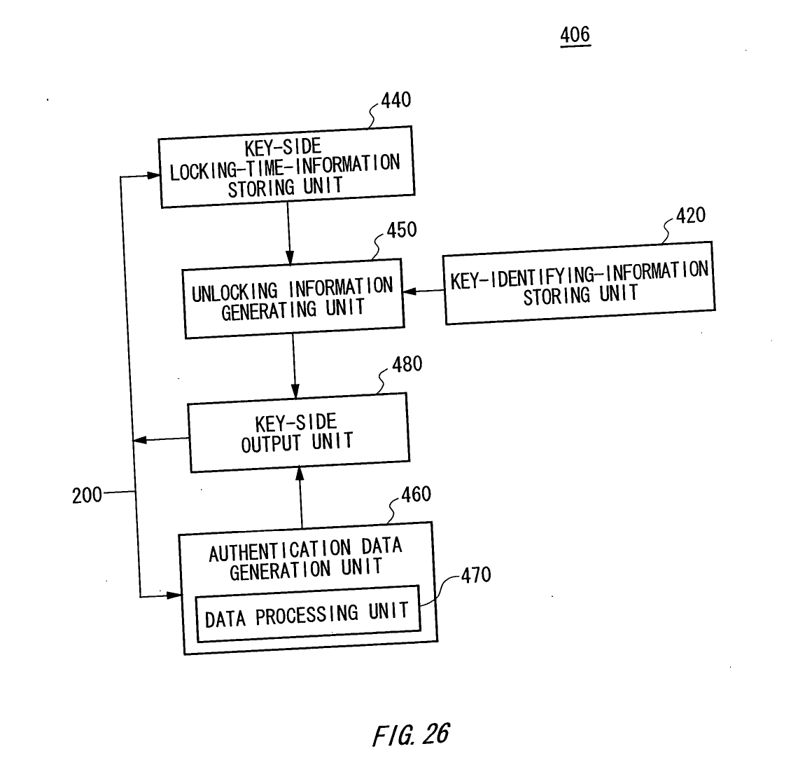

Moreover, during unlocking the locker, the portable key apparatus 400 may generate and output unlocking information, which is the other information based on the key identifying information and the locker identifying information, to the locking and unlocking apparatus 200 without transmitting the key identifying information and the locker identifying information as they are. In this case, a functional configuration of the transponder 406 is explained by means of FIG. 26. The transponder 406 has an unlocking information generating unit 450 in addition to a configuration shown in FIG. 11.

In other words, during unlocking the locker, the key-side locking-time-information storing unit 440 and the key-identifying-information storing unit 420 respectively output the locker identifying information and the key identifying information to the unlocking information generating unit 450. Then, the unlocking information generating unit 450 generates the unlocking information based on the locker identifying information and the key identifying information. The unlocking information is generated, e.g., by adding the date on which the key-side locking-time-information storing unit 440 stores the locker identifying information to the locker identifying information and the key identifying information. Then, the generated unlocking information is transmitted to the locking and unlocking apparatus 200 via the key-side output unit 480.

Then, the adequacy-of-unlocking deciding unit 360 of the locking and unlocking apparatus 200 decides whether the portable key apparatus 400 is the portable key apparatus 400 used during locking the locker based on the received unlocking information. This decision is performed by adding the same process as that performed by the unlocking information generating unit 450, namely, e.g., the date on which the unlocking information is received to, e.g., the locker identifying information and the key identifying information respectively stored on the locker-identifying-information storing unit 240 and the locker-side locking-time-information storing unit 300 of the locking and unlocking apparatus 200, and checking the processed information with the unlocking information.

Then, when it has been decided whether the portable key apparatus 400 is the portable key apparatus 400 used during locking the locker, the adequacy-of-unlocking deciding unit 360 allows the locking and unlocking mechanism 220 to be unlocked. Therefore, although a pair of the locker identifying information and the key identifying information leaks out, it is not possible to unlock the locking and unlocking apparatus 200. Therefore, the reliability of locker 100 rises.

Furthermore, when respectively using the date on which the user is going to unlock the locker and the date on which the user has locked the locker during generating the unlocking information and during authenticating the unlocking information, the locking and unlocking apparatus 200 cannot be unlocked when the date on which the user has locked the locking and unlocking apparatus 200 and the date on which the user is going to unlock the locker are different from each other. Therefore, it is not possible to use the locker 100 over several days.

In addition, the adequacy-of-unlocking deciding unit 360 of the locking and unlocking apparatus 200 may store the date on which the user has locked the locker. In this case, the unlocking information generating unit 450 generates the unlocking information using the date on which the user is going to unlock the locker. Then, the adequacy-of-unlocking deciding unit 360 checks the received unlocking information using the date on which the user has locked the locker.

As is apparent from the descriptions, according to the present invention, it is possible not to bother the user, e.g., by being able to freely select the vacant locker in the locker with an electronic key.

Although the present invention has been described by way of an exemplary embodiment, it should be understood that those skilled in the art might make many changes and substitutions without departing from the spirit and the scope of the present invention. It is obvious from the definition of the appended claims that embodiments with such modifications also belong to the scope of the present invention.

1. A locker system comprising a locker and a portable key apparatus operable to perform-locking and unlocking of said locker in communication with said locker, wherein
said portable key apparatus comprises:
a key-identifying-information storing unit that previously stores key identifying information that is identification information inherent in said portable key apparatus; and
a key-side output unit that outputs the key identifying information stored on the key-identifying-information storing unit to said locker during locking said locker,
said locker comprises:
a locker-identifying-information storing unit that previously stores locker identifying information that is identification information inherent in said locker; and
a locker-side output unit that reads the locker identifying information from the locker-identifying-information storing unit to output the information to said portable key apparatus during locking said locker,
said portable key apparatus further comprises a key-side locking-time-information storing unit that stores the locker identifying information received from the locker-side output unit during locking said locker,
said locker further comprises a locker-side locking-time-information storing unit that stores the key identifying information received from the key-side output unit during locking said locker, and
said locker further comprises an adequacy-of-unlocking deciding unit that decides the adequacy of unlocking of said locker based on the locker identifying information stored on the key-side locking-time-information storing unit, the key identifying information previously stored on the key-identifying-information storing unit, the key identifying information stored on the locker-side locking-time-information storing unit, and the locker identifying information previously stored on the locker-identifying-information storing unit.

2. The locker system as claimed in claim 1, wherein
said portable key apparatus further comprises an unlocking information generating unit that generates unlocking information to unlock said locker based on the locker identifying information stored on the key-side locking-time-information storing unit and the key identifying information stored on the key-identifying-information storing unit,
the key-side output unit of said portable key apparatus further outputs the unlocking information to said locker during unlocking said locker, and
the adequacy-of-unlocking deciding unit of said locker further checks the unlocking information received during unlocking said locker with the key identifying information stored on the locker-side locking-time-information storing unit and the locker identifying information previously stored on the locker-identifying-information storing unit and decides the adequacy of unlocking of said locker based on the checked result.

3. The locker system as claimed in claim 1, wherein
the key-side output unit of said portable key apparatus further outputs the locker identifying information stored on the key-side locking-time-information storing unit and the key identifying information previously stored on the key-identifying-information storing unit to said locker during unlocking said locker, and
the adequacy-of-unlocking deciding unit of said locker checks the locker identifying information and the key identifying information received during unlocking said locker with the key identifying information stored on the locker-side locking-time-information storing unit and the locker identifying information previously stored on the locker-identifying-information storing unit and decides the adequacy of unlocking of said locker based on the checked result.

4. The locker system as claimed in claim 1, wherein
information exchange between said locker and said portable key apparatus is performed using wireless communication system, said locker further comprises a holding section that holds
said portable key apparatus in a position of being able to send and receive the data between each other by radio, and
said portable key apparatus comprises an engaging section that is inserted into the holding section to engage with said locker.

5. The locker system as claimed in claim 4, wherein
said locker further comprises a locking and unlocking mechanism that locks and unlocks said locker by rotating the key mechanically and also is able to be rotated in a unlocking direction when the adequacy-of-unlocking deciding unit allows unlocking, and
the holding section of said locker has a mobile mechanism that moves along with said portable key apparatus and rotates the locking and unlocking mechanism with this movement to perform locking or unlocking of said locker.

6. The locker system as claimed in claim 4, wherein
said locker further comprises a temporary fixed unit that temporarily fixes said portable key apparatus held in the holding section to the holding section and also enables that said portable key apparatus is removed from the holding section on condition that the key-side locking-time-information storing unit has stored the locker identifying information and the locker-side locking-time-information storing unit has stored the key identifying information respectively.

7. The locker system as claimed in claim 1, wherein
said locker further comprises a locking and unlocking mechanism that locks or unlocks said locker by rotating the key mechanically,
said portable key apparatus further comprises an authentication data generation unit that generates authentication data indicating that said portable key apparatus is a normal product,
the key-side output unit of said portable key apparatus further outputs the authentication data to said locker during locking said locker,
said locker further comprises a verification unit that verifies whether said portable key apparatus is a normal product based on the authentication data, and
the locking and unlocking mechanism of said locker is able to be rotated when the verification unit has authenticated that said portable key apparatus is a normal product in the verification process.

8. The locker system as claimed in claim 7, wherein
the authentication data generation unit of said portable key apparatus and the verification unit of said locker respectively comprise a data processing unit that processes the input data using the same method,
the verification unit of said locker outputs data to the authentication data generation unit and also stores the data as it is during authenticating the key,
the authentication data generation unit generates the authentication data by processing the data by means of the data processing unit of the authentication data generation unit, and
the verification unit processes the data stored thereon by means of the data processing unit of the verification unit and verifies whether said portable key apparatus is a normal product based on the comparison result between the processed data and the authentication data received from the authentication data generation unit.

9. The locker system as claimed in claim 1, wherein
said locker further comprises:
a vacancy deciding unit that decides that said portable key apparatus does not lock the other locker when the locker identifying information is not already stored on the key-side locking-time-information storing unit during locking said locker; and
a locking and unlocking mechanism that locks or unlocks said locker by rotating the key mechanically and also is able to be rotated in a locking direction when the vacancy deciding unit decides that said portable key apparatus does not lock the other locker.

10. The locker system as claimed in claim 1, further comprising an administrative computer operable to store the key identifying information on said portable key apparatus and user identifying information identifying a user that holds said portable key apparatus in association with each other before using said locker.

11. The locker system as claimed in claim 10, wherein
the locker system further comprises a reader operable to read the locker identifying information stored on the key-side locking-time-information storing unit and the key identifying information previously stored on the key-identifying-information storing unit from said portable key apparatus after locking said locker, and
said administrative computer stores a pair of the locker identifying information and the key identifying information read from said reader in association with the user identifying information stored before the use of said locker.

12. A portable key apparatus that performs locking and unlocking of a locker in communication with the locker, comprising:
a key-identifying-information storing unit operable to previously store key identifying information that is identification information inherent in the portable key apparatus;
a key-side output unit operable to output the key identifying information stored on the key-identifying-information storing unit to the locker during locking the locker; and
a key-side locking-time-information storing unit operable to receive locker identifying information that identifies the locker from the locker to store the information during locking the locker,
said key-side output unit further outputs the key identifying information previously stored on the key-identifying-information storing unit and the locker identifying information stored on the key-side locking-time-information storing unit to the locker during unlocking the locker.

13. A locker that is locked and unlocked based on input from a portable key apparatus held by a user, comprising:
a locker-identifying-information storing unit operable to previously store locker identifying information that is identification information inherent in the locker;
a locker-side output unit operable to read the locker identifying information from said locker-identifying-information storing unit to output the information to the portable key apparatus during locking the locker;
a locker-side locking-time-information storing unit operable to receive key identifying information that identifies the portable key apparatus from the portable key apparatus to store the information during locking the locker; and
an adequacy-of-unlocking deciding unit operable to receive the key identification information inherent in the portable key apparatus from the portable key apparatus during unlocking the locker and the locker identifying information output and stored from said locker-side output unit to the portable key apparatus during locking the locker, check the received information with the locker identifying information previously stored on said locker-identifying-information storing unit and the key identifying information stored on the locker-side locking-time-information storing unit, and decide the adequacy of unlocking of the locker based on the checked result.

14. A locker system comprising a locker and a portable key apparatus operable to perform locking and unlocking of said locker in communication with said locker, wherein
said portable key apparatus comprises:
a key-identifying-information storing unit that previously stores key identifying information that is identification information inherent in said portable key apparatus; and
a key-side output unit that outputs the key identifying information stored on the key-identifying-information storing unit to said locker during locking said locker,
said locker comprises a locker-side locking-time-information storing unit that stores the key identifying information received from the key-side output unit during locking said locker,
the key-side output unit of said portable key apparatus further outputs the key identifying information stored on the key-identifying-information storing unit to said locker during unlocking said locker, and
said locker further comprises an adequacy-of-unlocking deciding unit that checks the key identifying information received during unlocking said locker with the key identifying information stored on the locker-side locking-time-information storing unit and decides the adequacy of unlocking of said locker based on the checked result.

15. A locker system comprising a locker and a portable key apparatus operable to perform locking and unlocking of said locker in communication with said locker, wherein
said locker comprises:
a locker-identifying-information storing unit that previously stores locker identifying information that is identification information inherent in said locker; and
a locker-side output unit that reads the locker identifying information from the locker-identifying-information storing unit to output the information to said portable key apparatus during locking said locker,
said portable key apparatus comprises:
a key-side locking-time-information storing unit that stores the locker identifying information received from the locker-side output unit during locking said locker; and
a key-side output unit that outputs the locker identifying information stored on the key-side locking-time-information storing unit to said locker during unlocking said locker, and
said locker further comprises an adequacy-of-unlocking deciding unit that checks the locker identifying information received during unlocking said locker with the locker identifying information previously stored on the locker-identifying-information storing unit and decides the adequacy of unlocking of said locker based on the checked result.

16. A locker locking and unlocking method that performs locking and unlocking of the locker using a portable key apparatus that communicates with the locker, comprising:
previously storing key identifying information that is identification information inherent in the portable key apparatus on the portable key apparatus;
previously storing locker identifying information that is identification information inherent in the locker on the locker;
outputting the key identifying information from the portable key apparatus to store the information on the locker and also outputting the locker identifying information from the locker to store the information on the portable key apparatus during locking the locker; and
deciding the adequacy of unlocking of the locker based on the key identifying information stored on the locker during locking the locker, the locker identifying information stored on the portable key apparatus during locking the locker, the locker identifying information previously stored on the locker, and the key identifying information previously stored on the portable key apparatus.

17. The locker locking and unlocking method as claimed in claim 16, wherein
information exchange between the locker and the portable key apparatus is performed using wireless communication system, and
the locking and unlocking are performed by inserting the portable key apparatus into a holding section that is provided in a position of being able to send and receive data between each other by radio in the locker to engage the portable key apparatus with the holding section.

18. The locker locking and unlocking method as claimed in claim 16, wherein
a locking and unlocking mechanism that locks or unlocks the locker by rotating the key mechanically is further provided in the locker,
the portable key apparatus generates authentication data indicating that the portable key apparatus is a normal product to output the data to the locker during locking the locker,
the locker verifies whether the portable key apparatus is a normal product based on the authentication data, and
the locking and unlocking mechanism of the locker is able to be rotated when the locker has authenticated that the portable key apparatus is a normal product in the verification process.

19. A locker locking and unlocking method that performs locking and unlocking of the locker using a portable key apparatus that communicates with the locker, comprising:
previously storing key identifying information that is identification information inherent in the portable key apparatus on the portable key apparatus;
outputting the key identifying information from the portable key apparatus to store the information on the locker during locking the locker; and
deciding the adequacy of unlocking of the locker based on the key identifying information previously stored on the portable key apparatus and the key identifying information stored on the locker during locking the locker.

20. A locker locking and unlocking method that performs locking and unlocking of the locker using a portable key apparatus that communicates with the locker, comprising:
previously storing locker identifying information that is identification information inherent in the locker on the locker;
outputting the locker identifying information from the locker to store the information on the portable key apparatus during locking the locker; and
deciding the adequacy of unlocking of the locker based on the locker identifying information previously stored on the locker and the locker identifying information stored on the portable key apparatus during locking the locker.

21. A machine readable medium storing computer program capable of being realized by a computer built in a portable key apparatus that performs locking and unlocking of a locker in communication with the locker, the program causes the computer to act as:
means for outputting key identifying information, which is previously stored on the computer and is identification information inherent in the portable key apparatus, from the portable key apparatus to the locker during locking the locker;
means for receiving locker identifying information that identifies the locker from the locker to store the information on the portable key apparatus during locking the locker; and
means for outputting the key identifying information and the locker identifying information stored on the portable key apparatus to the locker during unlocking the locker.

22. A machine readable medium storing computer program capable of being realized by a computer provided in a locker and for locking and unlocking the locker by way of a portable key apparatus held by a user, the program causes the computer to act as:
means for reading locker identifying information that is previously stored on the computer and is identification information inherent in the locker to output the information to the portable key apparatus during locking the locker;
means for receiving key identifying information inherent in the portable key apparatus from the portable key apparatus to store the information on a memory of the computer during locking the locker; and
means for storing the key identifying information previously stored on the portable key apparatus and the locker identifying information stored during locking the locker that are output from the portable key apparatus on the computer, for checking the output information with the key identifying information stored and the locker identifying information previously stored on the computer of the locker, and deciding the adequacy of unlocking of the locker based on the checked result.
